(19) United States
(12) Patent Application Publication
(10) Pub. No.: US 2003/0065099 A1
(43) Pub. Date: Apr. 3, 2003

(54) Block copolymers containing hydrogenated vinyl aromatic/(alpha-alkylstyrene) copolymer blocks

(76) Inventors: Stephen F. Hahn, Midland, MI (US); Frank S. Bates, St. Louis Park, MN (US); Michelle L. Hudack, Grand Blanc, MI (US); Jingjing Xu, Minneapolis, MN (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/224,982

(22) Filed: Aug. 20, 2002

Related U.S. Application Data
(60) Provisional application No. 60/322,282, filed on Sep. 14, 2001.

(51) Int. Cl. C08F 2/00

(52) U.S. Cl. 525/242

(57) ABSTRACT

The present invention is directed to a hydrogenated block copolymer comprising a hydrogenated conjugated diene polymer block and at least one hydrogenated vinyl aromatic/(alpha-alkylstyrene) copolymer block.

### CROSS REFERENCE STATEMENT

This application claims the benefit of U.S. Provisional Application No. 60/322,282, filed Sep. 14, 2001.

The present invention relates to hydrogenated aromatic block copolymers of vinyl aromatic and conjugated diene monomers.

### BACKGROUND

Vinyl aromatic polymers have been previously hydrogenated to produce clear, tough plastics having a higher glass transition temperature (Tg) than their non-hydrogenated polymer counterparts. In order to further toughen these materials, hydrogenated block copolymers of vinyl aromatics and conjugated dienes were produced. However, higher Tg materials are still desired. Alpha-alkylstyrene polymers, such as alpha-methylstyrene, have been previously suggested as a high Tg alternative to styrenic polymers. However, these polymers require extreme reaction conditions which are costly and inconvenient. Additionally, if hydrogenated to further enhance the Tg, alpha-methylstyrene homopolymer (or homopolymer block within a block copolymer) suffers severe molecular weight degradation.

Therefore, there still remains a need for hydrogenated aromatic polymers having a higher Tg, without the disadvantages of the prior art.

### SUMMARY

The present invention is directed to hydrogenated block copolymers comprising at least one hydrogenated conjugated diene polymer block and at least one fully or substantially hydrogenated vinyl aromatic/(alpha-alkylstyrene) copolymer block.

It has been discovered that conjugated diene block copolymers comprising at least one block of vinyl aromatic/(alpha-alkylstyrene) copolymer can be successfully hydrogenated without the molecular weight degradation seen in alpha-alkylstyrene homopolymer blocks. These polymers have very high Tg and all the desirable properties of other hydrogenated block copolymers of vinyl aromatic and conjugated diene monomers.

### DETAILED DESCRIPTION

The hydrogenated block copolymers of the present invention comprise at least one fully or substantially hydrogenated vinyl aromatic/(alpha-alkylstyrene) copolymer block. The vinyl aromatic/(alpha-alkylstyrene) copolymer block is first prepared by copolymerizing a vinyl aromatic monomer and an alpha-alkylstyrene monomer to form a copolymer segment.

Vinyl aromatic monomers include, but are not limited to those described in U.S. Pat. Nos. 4,666,987, 4,572,819 and 4,585,825, which are herein incorporated by reference. Preferably, the monomer is of the formula:

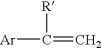

wherein R′ is hydrogen, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, all isomers of vinyl toluene, especially paravinyltoluene, all isomers of ethyl styrene, propyl styrene, vinyl biphenyl, vinyl naphthalene, vinyl anthracene and the like, and mixtures thereof. Homopolymers may have any stereostructure including syndiotactic, isotactic or atactic; however, atactic polymers are preferred. Preferably, the vinyl aromatic monomer is styrene.

Alpha-alkylstyrenes are of the formula above, wherein Ar is a benzene ring and R′ is a C₁-C₆ linear hydrocarbon. Examples include alpha-methylstyrene, alpha-ethylstyrene and the like, with alpha-methylstyrene being most preferred. Such monomers and methods for their preparation are well known in the art.

Copolymers comprising vinyl aromatics and alpha-alkylstyrenes are well known in the art and can be prepared by free radical, cationic or anionic polymerization techniques. Anionic polymerizations are disclosed in U.S. Pat. Nos. 2,975,160; 3,030,346; 3,031,432; 3,139,416; 3,157,604; 3,159,587; 3,231,635; 3,498,960; 3,590,008; 3,751,403; 3,954,894; 4,183,877; 4,196,153; 4,196,154; 4,200,713 and 4,205,016, all of which are incorporated herein by reference. Anionic polymerization can be employed to prepare copolymers of vinyl aromatic and alpha-alkylstyrene containing limited segments of adjacent alpha-alkylstyrene moieties. The term ‘limited segments’ refers to an average polymeric chain length of alpha-alkylstyrene moieties, such that significant degradation does not occur upon hydrogenation. Significant degradation can be defined by a loss of molecular weight of more than 10 percent of the polymer block. Typically, the average number of adjacent alpha-alkylstyrene moieties will be less than 20, preferably less than 10, more preferably less than 5 and most preferably less than 2. The polymerization is performed at a temperature above the ceiling temperature of the alpha-alkylstyrene. The ‘ceiling temperature’ is defined as the temperature at which depolymerization of a polymer is thermodynamically favored over polymerization. Accordingly, at temperatures above the ceiling temperature, no further chain growth of a homopolymer of the monomeric species in question may occur. A particular example of this type of polymerization is an alternating copolymer, where it is possible to obtain a maximum of one alpha-alkylstyrene unit for every vinyl aromatic monomer unit in the copolymer, and wherein the alpha-alkylstyrene unit is situated between vinyl aromatic monomer units. Typically, such vinyl aromatic/(alpha-alkylstyrene) copolymer segments contain from 5 to 70% by weight alpha-alkylstyrene, preferably from 10, more preferably from 20, and most preferably from 30 to 60, preferably to 55, more preferably to 50 and most preferably to 40% by weight, based on the total weight of the vinyl aromatic/(alpha-alkylstyrene) copolymer segment.

Typically, the vinyl aromatic and alpha-alkylstyrene monomers are contacted with an anionic initiator at a temperature above the ceiling temperature of the alpha-alkylstyrene monomer. The anionic initiator is typically an organometallic anionic polymerization initiating compound. The initiator is typically an alkyl or aryl alkali metal compound, particularly lithium compounds with C₁₋₆ alkyl, C₆ aryl, or C₇₋₂₀ alkylaryl groups. Such initiators can be monofunctional or polyfunctional metal compounds including the multifunctional compounds described, in U.S. Pat. No. 5,171,800 and U.S. Pat. No. 5,321,093, which are incorporated herein by reference. It is advantageous to use organolithium compounds such as ethyl-, propyl-, isopropyl-, n-butyl-, sec.-butyl-, tert.-butyl, phenyl-, hexyl-diphenyl-, butadienyl-, polystyryl-lithium, or the multifunctional compounds hexamethylene-dilithium, 1,4-dilithium-butane, 1,6-dilithium-hexane, 1,4-dilithium-2-butene, or 1,4-dilithium-benzene. Preferably, the initiator is n-butyl- and/or sec.-butyl-lithium.

The resulting polymer is a vinyl aromatic and alpha-alkylstyrene copolymer block containing limited segments of alpha-alkylstyrene monomeric moieties in the copolymer matrix. The amount of vinyl aromatic monomer present in the polymerization can be adjusted in order to prepare copolymers having any desired amount of vinyl aromatic monomer from 30 to 95 weight percent, based on the total weight of the copolymer.

The amount of initiator is well known in the art and can be easily ascertained by one skilled in the art without undue experimentation. Each mole of initiator gives rise to a discrete polymer chain, thus providing a well-defined relationship between the quantity of initiator, the quantity of monomer, and the polymer molecular weight.

The polymerization is typically conducted in the presence of a saturated hydrocarbon solvent or ether, benzene, toluene, xylene or ethylbenzene, but is preferably a hydrocarbon, such as cyclohexane or methylcyclohexane. The amount of solvent used in the polymerization step of the process of the present invention is typically from 50 to 90 percent by weight based on the total weight of the monomer/solvent mixture. Of particular utility are mixed solvent systems, where the primary solvent is a saturated hydrocarbon and the secondary solvent is a straight chain or cyclic ether. Mixed solvent systems of this type are known to facilitate the incorporation of alpha-alkylstyrene, as demonstrated in Polymer Preprints, Volume 26, #2, 1985, pages 16-17.

Polymerization can be conducted in a continuous polymerization reactor of the plug flow or backmixed type as described in U.S. Pat. No. 2,745,824; U.S. Pat. No. 2,989,517; U.S. Pat. No. 3,035,033; U.S. Pat. No. 3,747,899; U.S. Pat. No. 3,765,655; U.S. Pat. No. 4,859,748 and U.S. Pat. No. 5,200,476, which are incorporated herein by reference, The vinyl aromatic/(alpha-alkylstyrene) copolymer block segment is further reacted with a conjugated diene (and optionally a vinyl aromatic monomer in sequence) to form a block copolymer. For example, the vinyl aromatic/(alpha-alkylstyrene) copolymer block segment is reacted with butadiene to form a polybutadiene block in addition to the vinyl aromatic/(alpha-alkylstyrene) block. Alternatively the (vinyl aromatic/alpha-alkylstyrene)/butadiene block copolymer can be additionally reacted with a vinyl aromatic monomer or a vinyl aromatic/(alpha-alkylstyrene) copolymer to produce a triblock copolymer. Similarly, multiple block architectures such as tetrablock or pentablock copolymers can also be produced, and so on.

The conjugated diene monomer can be any monomer having 2 conjugated double bonds. Such monomers include for example 1,3-butadiene, 2-methyl-1,3-butadiene, 2-methyl-1,3 pentadiene, isoprene and similar compounds, and mixtures thereof.

In one embodiment, the conjugated diene polymer block is chosen from materials which remain amorphous after the hydrogenation process, or materials which are capable of crystallization after hydrogenation. Hydrogenated polyisoprene blocks remain amorphous, while hydrogenated polybutadiene blocks can be either amorphous or crystallizable depending upon their structure. Polybutadiene can contain either a 1,2 configuration, which hydrogenates to give the equivalent of a 1-butene repeat unit, or a 1,4-configuration, which hydrogenates to give the equivalent of an ethylene repeat unit. Polybutadiene blocks having at least approximately 40 weight percent 1,2-butadiene content, based on the weight of the polybutadiene block, provides substantially amorphous blocks with low glass transition temperatures upon hydrogenation. Polybutadiene blocks having less than approximately 40 weight percent 1,2-butadiene content, based on the weight of the polybutadiene block, provide crystalline blocks upon hydrogenation. Depending on the final application of the polymer it may be desirable to incorporate a crystalline block (to improve solvent resistance) or an amorphous, more compliant block. The conjugated diene polymer block may also be a conjugated diene copolymer, such as a conjugated diene/vinyl aromatic mixed or random copolymer, wherein the conjugated diene portion of the copolymer is at least 50 weight percent of the copolymer. In other words, the resulting block copolymer can comprise a vinyl aromatic/(alpha-alkylstyrene) copolymer block and a conjugated diene/vinyl aromatic copolymer block.

A block is herein defined as a polymeric segment of a copolymer which exhibits microphase separation from a structurally or compositionally different polymeric segment of the copolymer. Microphase separation occurs due to the incompatibility of the polymeric segments within the block copolymer. Microphase separation and block copolymers are widely discussed in “Block Copolymers-Designer Soft Materials”, PHYSICS TODAY, February, 1999, pages 32-38.

The temperature at which the block polymerization is conducted will vary according to the specific components, particularly initiator, but will generally vary from about −80° to about 140° C.

Methods of making block copolymers by anionic polymerization are well known in the art, examples of which are cited in Anionic Polymerization: Principles and Practical Applications, H. L. Hsieh and R. P. Quirk, Marcel Dekker, New York, 1996. In one embodiment, block copolymers are made by sequential monomer addition to a carbanionic initiator such as sec-butyl lithium or n-butyl lithium. In another embodiment, a pentablock copolymer can be made by coupling a triblock material with a divalent coupling agent such as 1,2-dibromoethane, dichlorodimethylsilane, or phenylbenzoate. In this embodiment, a small chain (less than 10 monomer repeat units) of a conjugated diene polymer can be reacted with the vinyl aromatic polymer coupling end to facilitate the coupling reaction. Vinyl aromatic polymer blocks are typically difficult to couple, therefore, this technique is commonly used to achieve coupling of the vinyl aromatic polymer ends. The small chain of diene polymer does not constitute a distinct block since no microphase separation is achieved. The coupled structure achieved by this method is considered to be the functional equivalent of the ABABA pentablock copolymer structure. Coupling reagents and strategies which have been demonstrated for a variety of anionic polymerizations are discussed in Hsieh and Quirk, Chapter 12, pgs. 307-331. In another embodiment, a difunctional anionic initiator is used to initiate the polymerization from the center of the block system, wherein subsequent monomer additions add equally to both ends of the growing polymer chain. An example of a such a difunctional initiator is 1,3-bis(1-phenylethenyl) benzene treated with organolithium compounds, as described in U.S. Pat. Nos. 4,200,718 and 4,196,154, which are herein incorporated by reference.

The block copolymers typically contain from 5 to 95 weight percent of the vinyl aromatic/(alpha-alkylstyrene) copolymer block, generally from 5, preferably from 10, more preferably from 15 and most preferably from 20 to 95, preferably to 90, more preferably to 85 and most preferably to 80 weight percent, based on the total weight of the block copolymer.

The block copolymers typically contain from 95 to 5 weight percent conjugated diene polymer block, generally from 95, preferably from 90, more preferably from 85 and most preferably from 80 to 5, preferably to 10, more preferably to 15 and most preferably to 20 weight percent, based on the total weight of the block copolymer.

If the block copolymer additionally contains vinyl aromatic polymer block, such as in a vinyl aromatic/(alpha-alkylstyrene)-conjugated diene-vinyl aromatic block copolymer, it typically contains from 10 to 60 weight percent, generally from 10, preferably from 20, more preferably from 25 and most preferably from 30 to 60, preferably to 50, more preferably to 45 and most preferably to 40, based on the total weight of the block copolymer.

The vinyl aromatic/(alpha-alkylstyrene)-conjugated diene block copolymer is then hydrogenated to remove sites of both linear and aromatic unsaturation. Methods of hydrogenating aromatic polymers are well known in the art such as that described in U.S. Pat. No. 5,700,878 by Hahn and Hucul, wherein aromatic polymers are hydrogenated by contacting the aromatic polymer with a hydrogenating agent in the presence of a silica supported metal hydrogenation catalyst having a narrow pore size distribution and large pores.

Alternatively, the polymer solution can be hydrogenated using a mixed hydrogenation catalyst. The mixed hydrogenation catalyst is characterized in that it comprises a mixture of at least two components. The first component comprises any metal which will increase the rate of hydrogenation and includes nickel, cobalt, rhodium, ruthenium, palladium, platinum, other Group VIII metals, or combinations thereof. Preferably rhodium and/or platinum is used. The second component used in the mixed hydrogenation catalyst comprises a promoter which inhibits deactivation of the Group VIII metal(s) upon exposure to polar materials, and is herein referred to as the deactivation resistant component. Such components preferably comprise rhenium, molybdenum, tungsten, tantalum or niobium or mixtures thereof.

The amount of the deactivation resistant component is at least an amount which significantly inhibits the deactivation of the Group VIII metal component when exposed to polar impurities within a polymer composition, herein referred to as a deactivation inhibiting amount. Deactivation of the Group VIII metal is evidenced by a significant decrease in hydrogenation reaction rate. This is exemplified in comparisons of a mixed hydrogenation catalyst and a catalyst containing only a Group VIII metal component under identical conditions in the presence of a polar impurity, wherein the catalyst containing only a Group VIII metal component exhibits a hydrogenation reaction rate which is less than 75 percent of the rate achieved with the mixed hydrogenation catalyst.

Preferably, the amount of deactivation resistant component is such that the ratio of the Group VIII metal component to the deactivation resistant component is from 0.5:1 to 10:1, more preferably from 1:1 to 7:1, and most preferably from 1:1 to 5:1.

The catalyst can consist of the components alone, but preferably the catalyst additionally comprises a support on which the components are deposited. In one embodiment, the metals are deposited on a support such as a silica, alumina or carbon. In a more specific embodiment, a silica support having a narrow pore size distribution and surface area greater than 10 meters squared per gram (m²/g) is used.

The pore size distribution, pore volume, and average pore diameter of the support can be obtained via mercury porosimetry following the proceedings of ASTM D-4284-83.

The pore size distribution is typically measured using mercury porosimetry. However, this method is only sufficient for measuring pores of greater than 60 angstroms. Therefore, an additional method must be used to measure pores less than 60 angstroms. One such method is nitrogen desorption according to ASTM D-4641-87 for pore diameters of less than about 600 angstroms. Therefore, narrow pore size distribution is defined as the requirement that at least 98 percent of the pore volume is defined by pores having pore diameters greater than 300 angstroms and that the pore volume measured by nitrogen desorption for pores less than 300 angstroms, be less than 2 percent of the total pore volume measured by mercury porosimetry.

The surface area can be measured according to ASTM D-3663-84. The surface area is typically between 10 and 100 m²/g, preferably between 15 and 90 with most preferably between 50 and 85 m²/g.

The desired average pore diameter is dependent upon the polymer which is to be hydrogenated and its molecular weight (Mn). It is preferable to use supports having higher average pore diameters for the hydrogenation of polymers having higher molecular weights to obtain the desired amount of hydrogenation. For high molecular weight polymers (Mn>200,000 for example), the typical desired surface area can vary from 15 to 25 m²/g and the desired average pore diameter from 3,000 to 4000 angstroms. For lower molecular weight polymers (Mn<100,000 for example), the typical desired surface area can vary from 45 to 85 m²/g and the desired average pore diameter from 300 to 700 angstroms although larger pore diameters are also acceptable.

Silica supports are preferred and can be made by combining potassium silicate in water with a gelation agent, such as formamide, polymerizing and leaching as exemplified in U.S. Pat. No. 4,112,032. The silica is then hydrothermally calcined as in Iler, R. K., The Chemistry of Silica, John Wiley and Sons, 1979, pp. 539-544, which generally consists of heating the silica while passing a gas saturated with water over the silica for about 2 hours or more at temperatures from about 600° C. to about 850° C. Hydrothermal calcining results in a narrowing of the pore diameter distribution as well as increasing the average pore diameter. Alternatively, the support can be prepared by processes disclosed in Iler, R. K., The Chemistry of Silica, John Wiley and Sons, 1979, pp. 510-581.

A silica supported catalyst can be made using the process described in U.S. Pat. No. 5,110,779, which is incorporated herein by reference. An appropriate metal, metal component, metal containing compound or mixtures thereof, can be deposited on the support by vapor phase deposition, aqueous or nonaqueous impregnation followed by calcination, sublimation or any other conventional method, such as those exemplified in Studies in Surface Science and Catalysis, “Successful Design of Catalysts” V. 44, pg. 146-158, 1989 and Applied Heterogeneous Catalysis pgs. 75-123, Institute Francais du Pétrole Publications, 1987. In methods of impregnation, the appropriate metal containing compound can be any compound containing a metal, as previously described, which will produce a usable hydrogenation catalyst which is resistant to deactivation. These compounds can be salts, coordination complexes, organometallic compounds or covalent complexes.

Typically, the total metal content of the supported catalyst is from 0.1 to 10 wt. percent based on the total weight of the silica supported catalyst. Preferable amounts are from 2 to 8 wt. percent, more preferably 0.5 to 5 wt. percent based on total catalyst weight.

The amount of supported catalyst used in the hydrogenation process is much smaller than the amount required in conventional unsaturated polymer hydrogenation reactions due to the high reactivity of the hydrogenation catalysts. Generally, amounts of less than 1 gram of supported catalyst per gram of unsaturated polymer are used, with less than 0.5 gram being preferred and less than 0.2 being more preferred. The amount of supported catalyst used is dependent upon the type of process, whether it is continuous, semi-continuous or batch, and the process conditions, such as temperature, pressure and reaction time wherein typical reaction times may vary from about 5 minutes to about 5 hours. Continuous operations can typically contain 1 part by weight supported catalyst to 200,000 or more parts unsaturated polymer, since the supported catalyst is reused many times during the course of continuous operation. Typical batch processes can use 1 part by weight supported catalyst to 15 parts unsaturated polymer. Higher temperatures and pressures will also enable using smaller amounts of supported catalyst.

The hydrogenation reaction is preferably conducted in a hydrocarbon solvent in which the polymer is soluble and which will not hinder the hydrogenation reaction. The solvent is preferably the same solvent in which the polymerization was conducted. Typically, the polymer solution obtained form the polymerization step is diluted further with additional solvent prior to hydrogenation. Typically, the polymer solution contains from 10 to 25 wt. percent, preferably from 10 to 20 wt. percent polymer based on the total weight of the solution prior to hydrogenation. Preferably the solvent is a saturated solvent such as cyclohexane, methylcyclohexane, ethylcyclohexane, cyclooctane, cycloheptane, dodecane, dioxane, branched hydrocarbons, especially branched hydrocarbons which have no more than one hydrogen atom at the branch point, a boiling temperature of more than 45° C. and an ignition temperature greater than 280° C., isopentane, decahydronaphthalene or mixtures thereof, with cyclohexane being the most preferred.

The temperature at which the hydrogenation is conducted can be any temperature at which hydrogenation occurs without significant degradation of the polymer. Degradation of the polymer can be detected by a decrease in Mn, an increase in polydispersity or a decrease in glass transition temperature, after hydrogenation. Significant degradation in polymers having a polydispersity between 1.0 and about 1.2 can be defined as an increase of 30 percent or more in polydispersity after hydrogenation. Preferably, polymer degradation is such that less than a 20 percent increase in polydispersity occurs after hydrogenation, most preferably less than 10 percent. In polymers having polydispersity greater than about 1.2, a significant decrease in molecular weight after hydrogenation indicates that degradation has occurred. Significant degradation in this case is defined as a decrease in Mn of 20 percent or more. Preferably, a Mn decrease after hydrogenation will be less than 10 percent.

Typical hydrogenation temperatures are from about 40° C. preferably from about 100° C., more preferably from about 110° C., and most preferably from about 120° C. to about 250° C., preferably to about 200° C., more preferably to about 180° C., and most preferably to about 170° C.

The pressure of the hydrogenation reaction is not critical, though hydrogenation rates increase with increasing pressure. Typical pressures range from atmospheric pressure to 70 MPa, with 0.7 to 10.3 MPa being preferred.

The reaction vessel is purged with an inert gas to remove oxygen from the reaction area. Inert gases include but are not limited to nitrogen, helium, and argon, with nitrogen being preferred.

The hydrogenating agent can be any hydrogen producing compound which will efficiently hydrogenate the unsaturated polymer. Hydrogenating agents include but are not limited to hydrogen gas, hydrazine and sodium borohydride. In a preferred embodiment, the hydrogenating agent is hydrogen gas.

The amount of olefinic hydrogenation can be determined using Infrared or proton NMR techniques. The amount of aromatic hydrogenation can be measured using UV-VIS spectroscopy. Cyclohexane solutions of polystyrene give a very distinct absorption band for the aromatic ring at about 260.5 nm. This band gives an absorbance of 1.000 with a solution concentration of 0.004980 moles of aromatic per liter in a 1 cm cell. After removing the catalyst via filtration (using a 0.50 micrometer (>m) “TEFLON™” filter, Millipore FHUP047) the reaction mixture is placed in a UV cell and the absorbance measured. The absorbance is dependent upon concentration. The hydrogenated polymer products are typically measured at higher concentrations since they are not diluted before the absorbance is measured. Since the reaction solution is about 15-30 times more concentrated than the standards, small amounts of residual unsaturation can be accurately measured.

Typical aromatic hydrogenation levels for the hydrogenated polymer produced can range from 80 to 100 percent. Preferably, fully or substantially hydrogenated polymers are produced which have been hydrogenated to a level of at least 80 percent aromatic hydrogenation, generally at least 85 percent, typically at least 90 percent, advantageously at least 95 percent, more advantageously at least 98 percent, preferably at least 98 percent, more preferably at least 99.5 percent, and most preferably at least 99.8 percent. The term ‘level of hydrogenation’ refers to the percentage of the original unsaturated bonds which become saturated upon hydrogenation. The level of hydrogenation in hydrogenated vinyl aromatic polymers is determined using UV-VIS spectrophotometry, while the level of hydrogenation in hydrogenated diene polymers is determined using proton NMR.

The weight average molecular weight (Mn) of the aromatic polymers that are hydrogenated is typically from 10,000 to 3,000,000, more preferably from 50,000 to 1,000,000, and most preferably from 50,000 to 500,000. As referred to herein, Mn refers to the number average molecular weight as determined by gel permeation chromatography (GPC).

The hydrogenated polymer is then optionally isolated by subjecting the hydrogenated polymer solution to a finishing process such as devolatilization. Any conventional finishing process can be used to isolate the hydrogenated polymer produced.

It has been surprisingly discovered that by utilizing the small units of alpha-alkylstyrene in the block copolymer, that no significant polymer degradation occurs, while the Tg of the material is significantly increased after hydrogenation.

The Tg of the polymers produced is advantageously higher than previous polymers. Typically, the Tg is above 140, preferably above 150, more preferably above 160, most preferably above 165° C.

In one embodiment, the hydrogenated polymer of the present invention is a hydrogenated styrene/(alpha-methylstyrene)-butadiene block copolymer (H(SAMS-B)). In another embodiment, the hydrogenated polymer is a hydrogenated styrene/(alpha-methylstyrene)-butadiene-styrene block copolymer(H(SAMS-B-S)). In yet another embodiment, the hydrogenated polymer is a styrene/(alpha-methylstyrene)-butadiene-styrene/(alpha-methylstyrene) block copolymer (H(SAMS-B-SAMS)).

The following examples are provided to illustrate the present invention. The examples are not intended to limit the scope of the present invention and they should not be so interpreted. Amounts are in weight parts or weight percentages unless otherwise indicated.

Preparation I

46,704 Mn styrene/(alpha-methylstyrene)-butadiene-styrene/(alpha-methylstyrene) or (SAMS-B-SAMS) Block Copolymer. (Block Mn's of 15,520-14,599-16,585)

1725 mL of purified cyclohexane is added to a 2500 mL reactor and heated to 50° C. alpha-Methylstyrene(432 g, 6.92 mol) is added and titrated with 3.8 mL of 0.2 M sec-butyllithium solution. sec-Butyl butyl lithium solution (16.84 g, 0.2 M in cyclohexane) is then added to the solution. Polymerization is initiated as 55.1 g of styrene is added, giving a styrene:alpha-methylstyrene ratio of 1:7. The polymerization is conducted for 25 minutes, followed by the addition of 54.59 g of 1,3 butadiene. The butadiene is polymerized for 1 hour and 25 minutes, followed by the addition of 54.6 g of styrene. After 40 minutes, 2-3 drops of tetrahydrofuran is added to the reactor to commence crossover from butadiene polymerization to styrene/alpha-methylstyrene copolymerization. The styrene/(alpha-methylstyrene) is copolymerized until the solution changes from orange to deep red (approximately 10 minutes). The polymerization is then terminated with 1 mL of deoxygenated 2-propanol.

The polymerization is sampled after each block is polymerized. Individual block size and polymer Mn (amu) is determined by gel permeation chromatography (GPC) analysis compared to polystyrene and polybutadiene standards.

The polydispersity of the polymer is 1.06. Composition by ¹H NMR analysis is 77% SAMS and by GPC from the apparent peak molecular weight analysis 72% SAMS. The composition of alpha-methylstyrene in SAMS block 1 and 3 is determined by ¹H NMR to be 30% and 7% respectively.

Preparation II

72,169 Mn styrene-butadiene-(styrene/alpha-methylstyrene) or S-B-SAMS Block Copolymer. (Block Mn's of 23,921-17,166-31,082)

1715 mL of purified cyclohexane is added to a 2500 mL reactor and heated to 58° C. sec butyl lithium solution (9.86 g) 0.345 M in cyclohexane) is added to the reactor. Polymerization is initiated as 82.5 g of styrene is added. The polymerization is conducted for 25 minutes, followed by the addition of 54.3 g of 1,3 butadiene. The butadiene is polymerized for 1 hour and 30 minutes, followed by the addition of 1.5 g of styrene to commence crossover from butadiene polymerization to styrene/alpha-methylstyrene copolymerization. After 10 minutes, 449 g of alpha-methylstyrene (blanked with 0.9 mL of see butyl lithium solution (0.345 M)) is added to the reactor. The remaining styrene (56.91 g) is then added to the reactor and the styrene/alpha-methylstyrene is copolymerized for approximately 30 minutes. The polymerization is then terminated with 1 mL of deoxygenated 2-propanol.

The polymerization is sampled after each block is polymerized. Individual block size and polymer Mn (amu) is determined by gel permeation chromatography (GPC) analysis compared to polystyrene and polybutadiene standards.

The polydispersity of the polymer is 1.1. Composition by ¹H NMR analysis is 79% SAMS and by GPC from the apparent peak molecular weight analysis 78% SAMS. The composition of alpha-methylstyrene in the third block (SAMS) is determined by ¹H NMR to be 34%.

Hydrogenation of Polymers From Preparation I and II.

The polymer synthesized in Preparation I and II is isolated from solution by precipitation from methanol, and is then dried to remove residual solvent. The dried polymer is dissolved in 1 l of cyclohexane, and is then filtered through a column containing activated alumina and added to a 2L pressure reactor equipped with mechanical stirring and a gas dispersion impeller. The polymer solution is transferred into the pressure reactor, and the transfer tube is rinsed into the reactor with a small volume of cyclohexane. The reactor head space is purged twice with 300 psig (20.7 bar) nitrogen. A catalyst slurry is then prepared by mixing 11 g of a Pt/SiO₂ catalyst in 250 mL cyclohexane, which is added to the reactor using an addition funnel. The reactor is then heated to 170° C., and the reactor is pressurized to 1300 psig (89.6 bar) with hydrogen. Additional hydrogen is added intermittently when the pressure drops due to consumption of H₂ during the reaction. After 16 hours, the remaining H₂ is vented and the solution is removed from the reactor. The solution is filtered through a 0.45 mm filter to remove the catalyst, and the solvent is removed in a vacuum oven.

UV analysis shows an extent of hydrogenation of greater than 99% of the styrene/(alpha-methylstyrene) units.

TABLE I

| | | Mn | S or SAMS | AMS^{†} | Tg* | Vicat⁹ | 1,2 B⁷ | Tg DSC |
|---|---|---|---|---|---|---|---|---|
| Ex. | Polymer | (g/mol) | (wt. %) | (wt. %) | (° C.) | (° C.) | (wt. %) | (° C.) |
| C¹ | H⁵(S⁶B⁷S) | 50,000 | 75 | 0 | 144 | 128 | 10 | 133 |
| 1 | H(SAMS⁸-B- | 54,000 | 75 | 20 | 156 | 144 | 9 | 152 |
| | SAMS) | | | | | | | |
| C² | H(SBS) | 85,000 | 75 | 0 | 154 | 139 | 10 | 144 |
| 2 | H(S-B-SAMS) | 85,000 | 79 | 17 | 168 | 152 | 10 | 156 |
| C³ | H(SBS) | 62,000 | 80 | 0 | 143 | — | 10 | 136 |
| 3 | H(SAMS-B- | 77,000 | 80 | 40 | 170 | 159 | 11 | 162 |
| | SAMS) | | | | | | | |
| C⁴ | H(SBSBS) | 175,000 | 50 | 0 | 135 | — | 90 | — |
| 4 | H(SAMS-B- | 178,000 | 50 | 25 | 152 | — | 90 | — |
| | SAMS-B | | | | | | | |
| | SAMS) | | | | | | | |
| 5 | H(SAMS-B- | 163,000 | 50 | 42 | 154 | — | 90 | — |
| | SAMS-B- | | | | | | | |
| | SAMS) | | | | | | | |
| 6 | H(SAMS-B- | 60,000 | 45 | 15 | 152 | — | 42 | — |
| | SAMS) | | | | | | | |

¹⁻⁴C = comparative examples
⁵H = Hydrogenated
⁶S = polymerized styrene
⁷B = polymerized butadiene, 1,2 B = 1,2 butadiene
⁸SAMS = polymerized styrene/alpha-methylstyrene
^{†}Weight percent AMS (alpha-methylstyrene) in the SAMS block segment
⁹VICAT ASTM method D1525-97a
*Tg is measured using (DMS), which is dynamic mechanical spectroscopy from the tan delta peak (G″/G′), frequency 1 rad/sec, 1-0.1% strain.

What is claimed is:

1. A fully or substantially hydrogenated block copolymer comprising at least one hydrogenated conjugated diene polymer block and at least one hydrogenated vinyl aromatic/(alpha-alkylstyrene) copolymer block.

2. The hydrogenated block copolymer of claim 1, wherein the hydrogenated conjugated diene polymer block is a hydrogenated butadiene or isoprene polymer block.

3. The hydrogenated block copolymer of claim 1, wherein the hydrogenated vinyl aromatic/(alpha-alkylstyrene) copolymer block is a hydrogenated styrene/(alpha-methylstyrene) copolymer block.

4. The hydrogenated block copolymer of claim 1, wherein the hydrogenated conjugated diene polymer block is from 5 to 95 weight percent of the hydrogenated block copolymer.

5. The hydrogenated block copolymer of claim 1, wherein the hydrogenated vinyl aromatic/(alpha-alkylstyrene) copolymer block is from 5 to 95 weight percent of the hydrogenated block copolymer

6. The hydrogenated block copolymer of claim 1, wherein the hydrogenated vinyl aromatic/(alpha-alkylstyrene) copolymer block comprises from 5 to 70 weight percent alpha-alkylstyrene, based on the weight of the hydrogenated vinyl aromatic/(alpha-alkylstyrene) copolymer.

7. The hydrogenated block copolymer of claim 1, which has been hydrogenated to a level of at least 80 percent aromatic hydrogenation.

8. The hydrogenated block copolymer of claim 7, which has been hydrogenated to a level of at least 95 percent aromatic hydrogenation.

9. The hydrogenated block copolymer of claim 1, which additionally contains a hydrogenated vinyl aromatic polymer block.

10. The hydrogenated block copolymer of claim 9, wherein the hydrogenated vinyl aromatic polymer block is from 10 to 60 weight percent, based on the total weight of the hydrogenated block copolymer,
